(19) United States
(12) Patent Application Publication
(10) Pub. No.: US 2025/0328062 A1
(43) Pub. Date: Oct. 23, 2025

(54) SHOULDER ADAPTER SYSTEM

(71) Applicant: NIHON VIDEO SYSTEM CO., LTD., Tsushima-shi (JP)

(72) Inventors: Hideyuki NUKUMI, Tsushima-shi (JP); Kentaro HASHIGUCHI, Tsushima-shi (JP); Akikazu HASHIGUCHI, Tsushima-shi (JP); Masayuki ITAKURA, Minato-ku (JP)

(73) Assignee: NIHON VIDEO SYSTEM CO., LTD., Tsushima-shi (JP)

(21) Appl. No.: 18/987,360

(22) Filed: Dec. 19, 2024

(30) Foreign Application Priority Data
Apr. 22, 2024 (JP) 2024-069067

(51) Int. Cl. G03B 17/56; H04N 23/53

(52) U.S. Cl. CPC G03B 17/561; G03B 17/566; H04N 23/531

(57) ABSTRACT

In order to improve convenience and comfort, the present invention provides a shoulder adapter system that does not require a lock lever during normal operation and allows a viewfinder to be fixed at any position with one hand via a free stop mechanism having a spring. Such a shoulder adapter system enables easily changing the viewfinder angle, even when the camera angle is changed quickly, and securely fixing the viewfinder position, even during intense camera work, using a lock lever.

### CROSS-REFERENCE TO RELATED APPLICATION

This application claims priority to Japanese Patent Application No. 2024-069067, filed on Apr. 22, 2024, which is incorporated by reference in its entirety for all purposes.

### BACKGROUND

### Field of the Invention

The present invention relates to attachment of a shoulder adapter to a video camera or a cinema camera, or attachment of an accompanying optical transmission device and a lens support rod.

### Description of the Related Art

When filming using a video camera or cinema camera, a tripod attachment adapter can be attached via screw holes on the bottom portion so as to facilitate tripod removal. In addition to this method of using a camera where the camera is attached to a tripod, there is also a method where the camera is placed on the user's shoulder. Both methods of camera usage are frequently employed, and shoulder adapters that are structured to be compatible with both the methods are widely used for filming (e.g., Patent Literature 1).

### Patent Literature

Patent Literature 1: Registered Design in Japan No. 1403206.

### SUMMARY

### Technical Problem

However, in the above-mentioned conventional methods, when moving the viewfinder from one angle to another, the user must repeat the series of actions of loosening the lock knob, moving the viewfinder, and tightening the lock knob. This means that changing the angle of the viewfinder itself is time-consuming when trying to quickly change the camera angle and film in various scenes. In recent years, the size and weight of lenses have been increasing due to higher definition videos and having to support 4K and 8K videos, and lens support rods are sometimes required to reduce the burden on camera joints. As existing shoulder adapters do not have a mechanism for attaching or detaching the rod, improving the convenience of filming has become the objective of the present invention.

The above circumstances have led to filing the present invention to improve convenience and comfort.

### Solution to Problem

According to the present invention, the following perspectives are provided.

(1) A shoulder adapter system that makes a camera for broadcasting and filming attachable to and detachable from a tripod attachment for broadcasting, comprising:
a shoulder adapter main body; and
a front attachment adapter, wherein
the shoulder adapter system is configured to allow the camera to be attached to at least one of the front attachment adapter and the shoulder adapter main body to make the camera placeable on a shoulder and attachable to and detachable from a tripod.

(2) The shoulder adapter system of (1), further comprising:
an optical transmission device attachment adapter, wherein
the optical transmission device attachment adapter is attached to the shoulder adapter main body in such a way to extend rearward of the shoulder adapter main body; and
the optical transmission device attachment adapter is attached to an optical transmission device accompanying the camera.

(3) The shoulder adapter system of (2), wherein
the optical transmission device attachment adapter includes an air hole.

(4) The shoulder adapter system of any one of (1) to (3), wherein
the front attachment adapter includes a lens support rod attachment portion to which a lens support rod is attachable.

(5) The shoulder adapter system of any one of (1) to (4), wherein
the shoulder adapter system is configured to allow the camera to be attached to both of the front attachment adapter and the shoulder adapter main body.

(6) The shoulder adapter system of any one of (1) to (4), wherein
the shoulder adapter system is configured to allow the camera to be attached to the front attachment adapter.

(7) The shoulder adapter system of any one of (1) to (4), wherein
the shoulder adapter system is configured to allow the camera to be attached to the shoulder adapter main body.

(8) A shoulder adapter system that makes a camera for broadcasting and filming attachable to and detachable from a tripod attachment for broadcasting, comprising:
a shoulder adapter main body;
a front attachment adapter; and
an optical transmission device attachment adapter, wherein
the front attachment adapter and the shoulder adapter main body are configured to allow the camera to be attached to at least one of the front attachment adapter and the shoulder adapter main body;
the front attachment adapter includes a lens support rod attachment portion to which a lens support rod is attachable;
the optical transmission device attachment adapter is attached to the shoulder adapter main body in such a way to extend rearward of the shoulder adapter main body; and
the optical transmission device attachment adapter is attached to an optical transmission device accompanying the camera.

(9) The shoulder adapter system of (8), wherein
the optical transmission device attachment adapter includes an air hole.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exploded perspective view of a shoulder adapter system according to an embodiment of the present invention.

FIG. 2 is an exploded side view of a shoulder adapter system according to an embodiment of the present invention.

FIG. 3 is a perspective view of a shoulder adapter system according to an embodiment of the present invention.

### DESCRIPTION OF THE PREFERRED EMBODIMENT

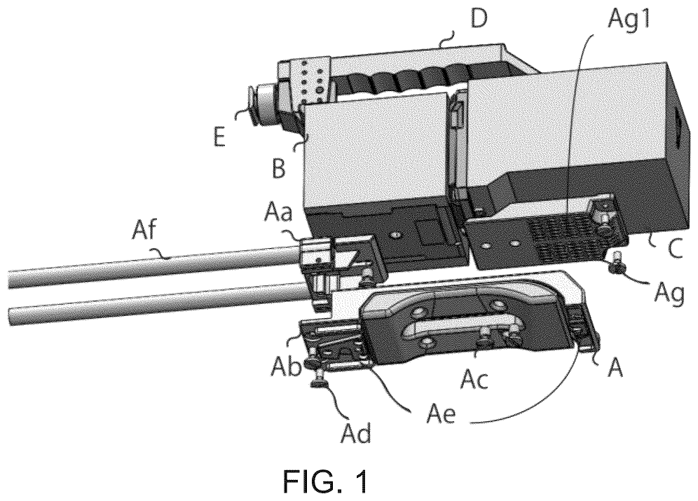

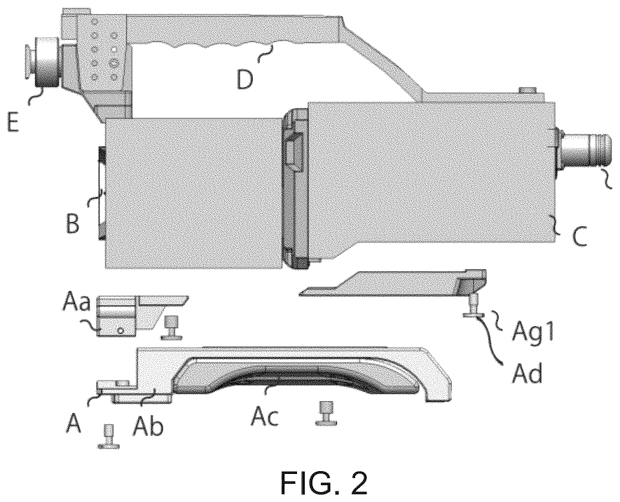

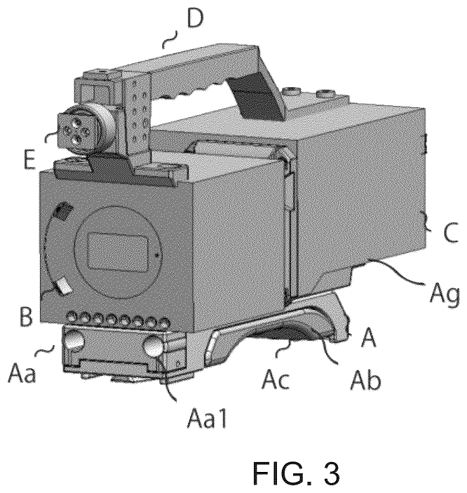

Hereinafter, a shoulder adapter system according to an embodiment of the present invention is described using FIGS. 1 to 3.

In the shoulder adapter system of this embodiment, the shoulder adapter A includes a shoulder adapter main body Ab and a front attachment adapter Aa. The shoulder adapter main body Ab includes a shoulder pad Ac and a tripod attachment Ae. Attachment screws Ad are used to attach a camera B. The attachment screws Ad are provided on the shoulder adapter main body Ab or the front attachment adapter Aa, to each of which the camera B is attachable. When using the camera on the shoulder, the user places the shoulder pad Ac on the shoulder, and when using the camera on a tripod, the user uses the tripod attachment Ae.

There are cases where an optical transmission device C accompanying the camera is attached to the back of the camera B. An optical transmission device attachment adapter Ag is attached using attachment screws Ad in such as way to fit the shape of the optical transmission device C accompanying the camera, and the optical transmission device C accompanying the camera and the optical transmission device attachment adapter Ag are attached to the shoulder adapter main body Ab. The optical transmission device attachment adapter Ag is attached in such a way to extend rearward of the shoulder adapter main body Ab. When using the camera on the shoulder, the user places the shoulder pad Ac on the shoulder, and when using the camera on a tripod, the user uses the tripod attachment Ae.

The optical transmission device attachment adapter Ag has an optical transmission device attachment adapter air hole Ag, which assists in cooling the optical transmission device C accompanying the camera.

A lens support rod attachment portion Aa1 in the front attachment adapter Aa has a structure to which the lens support rod Af can be attached. There are cases where the lens support rod attachment portion Aa1 has a hole whose shape corresponds to a φ19 or φ15 lens support rod, or cases where the lens support rod attachment portion Aa1 is not present, which makes the lens support rod Af incompatible.

A: shoulder adapter, Aa: front attachment adapter, Aa1: rod attachment portion, Ab: shoulder adapter main body, Ac: shoulder pad, Ad: attachment screw, Ae: tripod attachment, Af: lens support rod, Ag: optical transmission device attachment adapter, Ag1: optical transmission device attachment adapter air hole, B: camera, C: optical transmission device accompanying the camera, D: camera handle, E: viewfinder attachment bracket.

While illustrative embodiments have been illustrated and described, it will be appreciated that various changes can be made therein without departing from the spirit and scope of the invention.

1. A shoulder adapter system that makes a camera for broadcasting and filming attachable to and detachable from a tripod attachment for broadcasting, comprising:
a shoulder adapter main body; and
a front attachment adapter,
wherein
the shoulder adapter system is configured to allow the camera to be attached to at least one of the front attachment adapter and the shoulder adapter main body to make the camera placeable on a shoulder and attachable to and detachable from a tripod.

2. The shoulder adapter system of claim 1, further comprising:
an optical transmission device attachment adapter,
wherein
the optical transmission device attachment adapter is attached to the shoulder adapter main body in such a way to extend rearward of the shoulder adapter main body; and
the optical transmission device attachment adapter is attached to an optical transmission device accompanying the camera.

3. The shoulder adapter system of claim 2, wherein the optical transmission device attachment adapter includes an air hole.

4. The shoulder adapter system of claim 1, wherein the front attachment adapter includes a lens support rod attachment portion to which a lens support rod is attachable.

5. The shoulder adapter system of claim 1, wherein the shoulder adapter system is configured to allow the camera to be attached to both of the front attachment adapter and the shoulder adapter main body.

6. The shoulder adapter system of claim 1, wherein the shoulder adapter system is configured to allow the camera to be attached to the front attachment adapter.

7. The shoulder adapter system of claim 1, wherein the shoulder adapter system is configured to allow the camera to be attached to the shoulder adapter main body.

8. A shoulder adapter system that makes a camera for broadcasting and filming attachable to and detachable from a tripod attachment for broadcasting, comprising:
a shoulder adapter main body;
a front attachment adapter; and
an optical transmission device attachment adapter,
wherein
the front attachment adapter and the shoulder adapter main body are configured to allow the camera to be attached to at least one of the front attachment adapter and the shoulder adapter main body;
the front attachment adapter includes a lens support rod attachment portion to which a lens support rod is attachable;
the optical transmission device attachment adapter is attached to the shoulder adapter main body in such a way to extend rearward of the shoulder adapter main body; and
the optical transmission device attachment adapter is attached to an optical transmission device accompanying the camera.

9. The shoulder adapter system of claim 8, wherein the optical transmission device attachment adapter includes an air hole.
